(19) United States
(12) Patent Application Publication
(10) Pub. No.: US 2006/0029841 A1
(43) Pub. Date: Feb. 9, 2006

(54) High surface area, electronically conductive supports for selective CO oxidation catalysts

(75) Inventors: Olaf Conrad, Cliffwood, NJ (US); Lawrence Shore, Edison, NJ (US); Scott C. Schultz, Plainsboro, NJ (US)

Correspondence Address: ENGELHARD CORPORATION, 101 WOOD AVENUE, ISELIN, NJ, 08830, US

(73) Assignee: ENGELHARD CORPORATION

(21) Appl. No.: 10/915,241

(22) Filed: Aug. 9, 2004

(51) Int. Cl. H01M 8/06; H01M 8/10

(52) U.S. Cl. 429/19; 429/17; 429/30

(57) ABSTRACT

Provided is a fuel cell having a selective CO oxidation catalyst with an electronically conductive, particulate support dispersed on a gas diffusion membrane, and a membrane electrode assembly.

Also provided is a method of supplying a purified reformate gas to a membrane electrode assembly. The method includes contacting a reformate gas comprising H₂ and CO with a gas diffusion membrane while simultaneously adding an oxidant to the reformate gas to convert at least some of the CO to CO₂ to form the purified reformate gas. Dispersed on the gas diffusion membrane is a selective CO oxidation catalyst with an electronically conductive, particulate support. The purified reformate gas is then passed to the membrane electrode assembly.

The present invention relates to a fuel cell that is fed a supply of carbon monoxide (CO)-containing hydrogen rich fuel. The invention also relates to a method of operating a fuel cell that includes supplying a CO-containing, hydrogen rich fuel to the fuel cells that achieves reliable, long lasting and efficient power output.

In a polymer electrolyte membrane (PEM) fuel cell, hydrogen is electrochemically oxidized at the platinum surface of the anode. In those cases where the hydrogen is derived from a fossil fuel in a fuel reformer, the hydrogen fuel is typically contaminated with low levels of CO. The platinum electrodes at the anode are extremely sensitive to the poisoning effects of carbon monoxide in the hydrogen feed stream. Low levels of CO result in an anodic overpotential in the fuel cell. Even levels below 100 ppm of carbon monoxide can deteriorate the platinum anode and consequently, adversely affect fuel cell performance. Therefore, fuel cell processors and fuel cells are designed to reduce the levels of carbon monoxide in the hydrogen feed stream supplied to the platinum anode to as low a level as practical, i.e., preferably below 100 ppm, more preferably below 10 ppm.

Various technologies have been developed to minimize the CO contamination in the feed stream to below 10 ppm before the stream enters the anode side of a fuel cell. These technologies remediate CO by operating in the fuel cell processor, which converts a fossil fuel to a hydrogen-rich feed stream, or in the fuel cell, itself.

Fuel cell processors are often equipped with one or more catalyst beds containing a selective CO oxidation catalyst. These catalysts selectively oxidize residual carbon monoxide in reformate streams in preference to hydrogen according to the following reaction:
CO+½O₂→CO₂,
wherein hydrogen may comprise greater than 60% by volume or more of the gas stream composition. However, in systems with dynamically changing demands on the fuel cell processor, higher levels of CO often reach the fuel cell, and degrade the performance of the fuel cell.

In the fuel cell, introducing ruthenium on the catalyst surface of the platinum anode reduces the overpotential resulting from CO poisoning. Other materials are currently under review for uses as additives in a platinum anode. Alternatively or additionally, mixing low levels of air with the feed stream has been shown to effectively reduce the negative effective of CO on the fuel cell performance as disclosed in U.S. Pat. No. 4,910,009. One of the drawbacks associated with air bleed in the fuel cell is that the exothermic direct oxidation of CO to CO₂ and of hydrogen to water on the platinum anode surface inevitably creates large localized heats of reaction. This drawback often severely limits the long term stability of the membrane electrode assembly (MEA) on which the platinum anode is located. Moreover, the rate of air bleed limits the efficiency of the fuel cell by unwanted oxidation of the hydrogen fuel. Consequently, new fuel cell designs that remediate low levels of CO in the hydrogen with reduced air bleed are desirable.

U.S. Pat. No. 5,482,680 (“the '680 patent”) discloses a method and apparatus for selectively oxidizing carbon monoxide within the fuel cell stack using a quantity of catalyst contained within at least a portion of the fuel stream passageway within the stack. In certain embodiments of the apparatus disclosed therein, the catalyst is disposed as layers on porous electrically conductive sheet material, most preferably carbon fiber paper. The '680 patent discloses that the catalyst promotes the oxidation of carbon monoxide to carbon dioxide in the presence of oxygen.

### SUMMARY OF THE INVENTION

In one aspect, the invention relates to a fuel cell having a selective CO oxidation catalyst with an electronically conductive, particulate support dispersed on a gas diffusion membrane, and a membrane electrode assembly. Preferably, the electronically, conductive, particulate support has a surface area >50 m²/g. The gas diffusion membrane can be formed, for example, from woven or non-woven carbon fibers.

The electronically conductive, particulate support is generally selected from one or more of graphite, carbon black, an electronically conducting polymer, and an electronically conducting oxide. Preferably the electronically conductive particulate support is carbon black having a surface area >200 m²/g.

In one embodiment of the invention, the fuel cell also has an anode side flow field, wherein the gas diffusion membrane having the dispersed CO selective oxidation catalyst is interposed between the anode side flow field and the membrane electrode assembly.

In some embodiments, the selective CO oxidation catalyst contains a platinum group metal component selected from the group consisting of platinum-, palladium-, iridium-, rhodium-, ruthenium components and alloys thereof. In one preferred embodiment, the selective CO oxidation catalyst contains a platinum component. For instance, the selective CO oxidation catalyst can be present on the gas diffusion membrane at from 0.01 to 0.4 g/in² of a platinum component.

In alternative embodiments, the selective CO oxidation catalyst contains a metal component selected from the group consisting of copper-, gold components and alloys thereof.

In another aspect, the invention relates to a method of supplying a purified reformate gas to a membrane electrode assembly. The method includes contacting a reformate gas containing H₂ and CO with a gas diffusion membrane that has dispersed thereon a selective CO oxidation catalyst, while simultaneously adding an oxidant (e.g., O₂ which may be in form of air) to the reformate gas to convert at least some of the CO to CO₂ to form the purified reformate gas. The catalyst has an electronically conductive, particulate support. The method also includes passing the purified reformate gas to the membrane electrode assembly.

In some embodiments of the method, the CO in the reformate gas fed to the CO selective oxidation catalyst is present at from 5 to 5000 ppm. In preferred embodiments, there is between 10 and 300 ppm of CO in the reformate gas feed.

In another aspect, the invention relates to a method of supplying electrical current to an electrically-powered device having transient power demands. The method includes:

(a) contacting a reformate gas comprising H₂ and CO with a gas diffusion membrane having dispersed thereon a selective CO oxidation catalyst with an electronically conductive, particulate support while simultaneously adding an oxidant to the reformate gas to convert at least some of the CO to CO₂ to form purified reformate gas having a concentration of the CO to below 100 ppm (and particularly, below 10 ppm);

(b) passing the purified reformate gas to the membrane electrode assembly;

(c) generating a current to power the electronically-powered device, wherein the device has a power demand X; and,

(d) lowering the power demand of the electrically-powered device to at least 1/10*X; and maintaining the CO concentration in the purified reformate gas below 100 ppm (and particularly, below 10 ppm).

### BRIEF DESCRIPTION OF THE DRAWINGS

FIG. 1 is a side view depiction of a typical fuel cell (10).

FIG. 2 shows cell potential vs. current density curves generated by operating a fuel cell having a GDM with a 0.075 mg Pt/cm² selective CO oxidation catalyst having a carbon black support (GDM B1).

FIG. 3 shows cell potential vs. current density curves generated by operating a fuel cell having a GDM with a 0.035 mg Pt/cm² selective CO oxidation catalyst having a carbon black support (GDM B2).

FIG. 4 shows cell potential vs. current density curves generated by operating a fuel cell having a GDM with a 0.021 mg Pt/cm² selective CO oxidation catalyst having a carbon black support (GDM B3).

FIG. 5 shows cell potential vs. current density curves generated by operating a fuel cell having a GDM with a 0.075 mg Pt/cm² selective CO oxidation catalyst having a carbon black support (GDM C1).

FIG. 6 shows cell potential vs. current density curves generated by operating a fuel cell having a GDM with a 0.021 mg Pt/cm² selective CO oxidation catalyst having a carbon black support (GDM B3) and having a reference GDM with 0.026 mg Pt/cm² selective CO oxidation catalyst having an alumina support (GDM R1).

### DEFINITIONS

The following terms shall have, for the purposes of this application, the respective meanings set forth below.

“Active catalytic components” refer to catalytic agents such as precious metal components and base metal components that enhance the rate of oxidation of CO to CO₂.

“BET surface area” refers to the surface area as determined by the Brunauer, Emmett, Teller method for determining surface area by N₂ adsorption. Unless otherwise specifically stated, all references herein to the surface area refer to the BET surface area.

“Components,” when used in the context of active catalyst components, means the metal or an oxide thereof. By way of example, a platinum component refers to metallic platinum or an oxide thereof.

“High surface area” supports refer to catalyst supports having a surface area of at least 50 m²/g.

“Parts per million” (ppm) of gaseous components are expressed on the basis of the volume of a given gas composition.

### DETAILED DESCRIPTION OF THE INVENTION

The invention relates to a fuel cell having a gas diffusion medium (GDM) having dispersed thereon a selective CO oxidation catalyst with an electronically conductive, particulate support; and a MEA. The integral selective CO oxidation catalyst oxidizes CO to CO₂ in the hydrogen feed stream and prevents CO from poisoning the platinum anode which is a component of the MEA. Fuel cells that incorporate the inventive features accommodate transient CO spikes in the hydrogen feed stream with very high air bleed efficiency, and produce reliable power outputs.

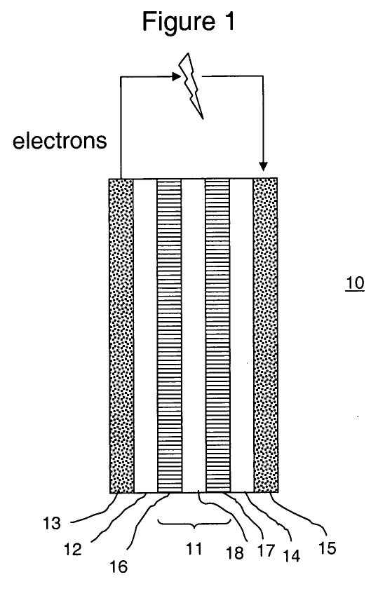

One embodiment of the inventive article denoted as 10 is illustrated in FIG. 1. The anode side GDM (12) with an integral selective CO oxidation catalyst is sandwiched between the MEA (11) and the anode side flow field (13). On the other side of the MEA is a cathode side GDM (14) which is positioned between the MEA and the cathode side flow field (15). The MEA has a platinum-based anode electrocatalyst (anode, 16) on the side of the MEA facing the anode side GDM (12), and a cathode electrocatalyst (cathode, 17) on the side facing the cathode side GDM. The MEA also has a polymer electrolyte membrane (PEM, 18) through which the protons produced at the anode traverse to the cathode where they are combined with oxygen to produce water.

In operation, a hydrogen feed stream is introduced through the anode side fluid flow plates, which generally contain channels to direct the feed stream to flow over the entire area constituted by the anode side flow field. The feed stream can be, for example, fed from a fuel cell reformer that converts a fossil fuel to hydrogen-containing gas. The feed stream diffuses through the anode side GDM to the anode. A small volume of air or other oxidant (e.g., purified O₂, O₃, H₂O₂) can be introduced simultaneously with the feedstream through one or more inlets in the fuel cell (e.g., in the anode side flow field). The feed stream contacts the selective CO oxidation catalyst dispersed on the GDM and oxidizes at least a portion of the CO contained therein to CO₂ before the feed stream contacts the anode. At the anode, H₂ splits into electrons (which ultimately collect in the anode side flow field), and protons (which are transported through the PEM where they are combined with oxygen to form H₂O at the cathode).

The overall operational efficiency of the fuel cell is improved by dispersing the active catalytic components of a selective CO oxidation catalyst on a high surface area, electronically conductive particulate support on the anode-side GDM. In this design, the fuel cell requires a smaller volume of air bleed to abate a given concentration of CO in the hydrogen feed stream as compared to fuel cells without an integral selective CO oxidation catalyst. Moreover, GDMs (e.g., carbon cloths, porous membranes) have substantially lower BET surface area than a high surface area particulate support. By dispersing the active catalytic components on to a high surface area support, the selective CO oxidation catalyst operates more effectively than in designs where the GDM supports the active components directly. The effective utilization of the selective CO oxidation catalyst in the fuel cell, for example, allows the fuel cell to accommodate transient CO spikes in the hydrogen feed stream and still provide reliable power outputs.

Deposition of the CO selective oxidation catalyst on to the GDM preferably leaves the properties of the GDM unadulterated to preserve the fuel cell's efficiency. The GDM serves several important roles in the fuel cell, which include electrical current transport, thermal conduction, gas distribution and protection of the electrode against physical stresses. Consequently, alterations to the GDM that negatively impact these roles result in lower fuel cell performance as manifested, for example, in a lower voltage output per a given current density from the fuel cell.

One primary component that affects the catalyst's chemical and physical properties and morphology, and consequently, also affects the GDM's properties, is the catalyst support. The inventive catalyst support is electronically conductive, preferably having an electrical resistivity of <1 ohm.cm on a sample compressed to 20 MPa. An electronically conductive support ensures that electrical current transport is uniform across the GDM so that charge is efficiently transported to the anode side flow field, where it is collected. Preferably, the support also provides good thermal conductivity (preferably >1 W/mK) and resists degradation by chemical species in the feed stream.

In addition, the particulate support preferably has a high BET surface area, preferably >50 m²/g, more preferably >200 m²/g, and most preferably >1000 m²/g to promote high utilization of the active catalyst components. High surface area supports assure that the contact areas for the active components of the selective CO oxidation catalyst are adequate to contact the hydrogen feed stream. Moreover, dispersion of the active catalyst components on to high surface area supports provides cost benefits, which are especially significant in the case of catalysts that contain precious metals.

The electronically conductive, particulate support is preferably selected from one or more of graphite, carbon black, an electronically conducting polymer, and an electronically conducting oxide. Examples of electronically conducting polymers include polyaniline, polythiophene, polyphenylenevinylenes and derivatives thereof. Examples of electronically conductive oxides include doped tin oxides, hydrous and anhydrous ruthenium oxides and titanium suboxides. Other choices of electronically conductive supports will be apparent to those of skill in the art.

In a preferred embodiment of the invention, the electronically conductive, particulate support is carbon black. Carbon black may have surface areas >200 m²/g and in some supports, >1200 m²/g.

The active catalyst components of the selective oxidation catalyst can be used without limitation, and include base metal components, precious metal components, and combinations thereof (including alloys). Preferred base metal active components include copper, iron and cerium components. Preferred precious metal active components include platinum group metal components and gold components. Preferred platinum group metal components include platinum, palladium, rhodium, and ruthenium components. In a preferred embodiment of the invention the selective CO oxidation catalyst includes a platinum component. In a particularly preferred embodiment, the selective CO oxidation catalyst includes a copper component in addition to a platinum component.

Determination of appropriate concentrations of active catalyst component disposed on the GDM depends, among other things, on the feed stream to be treated, on the CO tolerance of the anode and on the material costs. Skilled artisans can readily determine appropriate catalyst concentrations from consideration of such factors. When the active catalyst component is a platinum component, for example, the GDM generally contains platinum component at a concentration of 0.01 to 0.4 mg/cm², and preferably contains platinum component at a concentration of 0.02 to 0.25 mg/cm².

Active catalyst components and other catalyst additives (e.g., stabilizers and promoters) are preferably dispersed on the support by contacting the support with a water-soluble or water-dispersible precursor (e.g., salt or complex) of the active catalyst component (or additive precursor) for sufficient time to impregnate the support, followed by a drying step. Such precursors are apparent to those of skill in the art. For instance, useful platinum group metal precursors include, but are not limited to, platinum nitrate, amine-solubilized platinum hydroxide, palladium nitrate, palladium acetate and ruthenium nitrate. The support material containing the active catalyst precursor component can be heated to form the active metal or oxide thereof, preferably at a temperature below 350° C. Thermal treatment can be conducted prior to or after dispersion of the selective CO oxidation composition on the GDM.

The inventive fuel cell accommodates hydrogen feed streams containing varying amounts of CO. Depending on the source of the hydrogen stream, the CO concentration may vary. For example, from about 5 to 5000 ppm of CO are often encountered. In a preferred embodiment, the hydrogen feed stream contains from about 50 to 300 ppm of CO as it enters the fuel cell. Hydrogen feed streams with this level of CO can be obtained by treating an impure feed stream using known CO abatement strategies within the fuel cell processor such as selective CO oxidation, methanation, and combinations thereof.

Preferred selective oxidation catalyst compositions remain catalytically active below 100° C. More preferably, the catalyst composition maintain their activity below 80° C. When disposed on the GDM, the catalyst composition should remain active to at least 2 Amperes/cm² at a rate of 30 mL of H₂/min*cm² at a turndown ratio of 1:100.

A particularly desirable feature of the inventive article is that it offers a method for accommodating transient CO spikes in the hydrogen feed stream supplied to the fuel cell. Such CO spikes generally occur where the electrical power demands on the fuel cell change dramatically, particularly where there is a dramatic decrease in the power demand, such as by at least 90%. For instance, such spikes may occur where the electrically-powered device is changed from a high load operating state to an idling state. Such spikes are often in the range of 10 to 100 ppm, but the article can accommodate larger spikes. Transient CO spikes in the hydrogen feed stream may poison platinum-based catalysts and thereby reduce the power output of the fuel cell.

The method for accommodating transient CO spikes in the supply of the hydrogen feed stream includes:

(a) contacting a reformate gas comprising H₂ and CO with a gas diffusion membrane having dispersed thereon a selective CO oxidation catalyst with an electronically conductive, particulate support while simultaneously adding an oxidant to the reformate gas to convert at least some of the CO to CO₂ to form purified reformate gas having a concentration of the CO to below 100 ppm;

(b) passing the purified reformate gas to the membrane electrode assembly;

(c) generating a current to power the electronically-powered device, wherein the device has a power demand X (where X is a variable); and,

(d) lowering the power demand of the electrically-powered device to at least 1/10*X; and maintaining the CO concentration in the purified reformate gas below 100 ppm.

Preferably, the method is conducted wherein the CO concentration in the purified reformate in (a) and (b) is below 10 ppm. In some embodiments, the power demand of the electrically-powered device can be turned 1/100*X, while maintaining the CO concentration in the purified reformate gas below 100 ppm and preferably, below 10 ppm.

The following examples further illustrate the present invention, but of course, should not be construed as in any way limiting its scope.

### EXAMPLE 1

### Preparation of Platinum-Containing Catalyst Compositions

10 g of 20 wt. % Pt on carbon black (the carbon black having a BET surface area of 1400 m²/g) was dispersed in 100 mL deionized water at room temperature. Under vigorous stirring 2 g of NaOH pellets were added. The temperature was raised to 90° C. and the mixture allowed to stir for ˜30 minutes. A solution of 0.434 g of copper nitrate (Cu(NO₃)₂2.5H₂O) and 0.232 g of cerium nitrate (Ce(NO₃)₃6H₂O) in 35 mL of deionized water was added to this mixture at rate of 50 mL/h. After stirring for 60 minutes the slurry was filtered hot and thoroughly washed with deionized water.

Examples 2-5 exemplify the preparation of activated GDMs with various selective CO oxidation catalyst compositions containing electronically conductive particulate supports. Example 6 describes the preparation of a reference GDM containing an alumina support. Catalyst compositions were dispersed on to a carbon cloth, and the treated carbon cloth served as the anode side GDM in fuel cells in Example 7.

### EXAMPLE 2

### Preparation of an Activated GDM with 0.075 mg Pt/cm² using a Catalyst Powder of 19.5% Pt/1.5% CuO/0.9% CeO₂ (GDM B1)

3.0 g of 19.5% Pt/1.5% CuO/0.9% CeO₂ on carbon black were mixed with 60 g iso-propanol, 40 g glycerol and 2.4 g polytetrafluoroethylene (PTFE) emulsion (58.3% w/w of PTFE in water) and ball milled until a homogeneous suspension had formed. A small amount of the ink was applied to a carbon cloth patch of a 50 cm² size. A soft brush was used to evenly spread the ink over the carbon cloth surface. The ink readily penetrated through the entire bulk and it was apparent that the active particle were spread out over the whole surface area of the carbon cloth without blocking its porosity. The treated carbon cloth was placed into a convection oven at 150° C. to evaporate all volatiles. The completely dried piece was sintered at 350° C. for 30 min in a flow of N₂. The final loading was 0.075 mg Pt/cm². The carbon cloth was designated as GDM B1.

### EXAMPLE 3

### Preparation of an Activated GDM with 0.035 mg Pt/cm² using a Catalyst Powder of 19.5% Pt/1.5% CuO/0.9% CeO₂ (GDM B2)

3.0 g of 19.5% Pt/1.5% CuO/0.9% CeO₂ on carbon black were mixed with 60 g iso-propanol, 40 g glycerol and 2.4 g PTFE emulsion (58.3% w/w of PTFE in water) and ball milled until a homogeneous suspension had formed. A small a amount of the ink was applied to a carbon cloth patch of a 50 cm² size. A soft brush was used to evenly spread the ink over the carbon cloth surface. The ink readily penetrated through the entire bulk and it was apparent that the active particles were spread out over the whole surface area of the carbon cloth without blocking its porosity. The treated carbon cloth was placed into a convection oven at 150° C. to evaporate all volatiles. The completely dried piece was sintered at 350° C. for 30 min in a flow of N₂. The final loading was 0.035 mg Pt/cm². The carbon cloth was designated as GDM B2.

### EXAMPLE 4

### Preparation of an Activated GDM with 0.020 mg Pt/cm² using a Catalyst Powder of 19.5% Pt/1.5% CuO/0.9% CeO₂ (GDM B3)

3.0 g of 19.5% Pt/1.5% CuO/0.9% CeO₂ on carbon black were mixed with 60 g iso-propanol, 40 g glycerol and 2.4 g PTFE emulsion (58.3% w/w of PTFE in water) and ball milled until a homogeneous suspension had formed. A small amount of the ink was applied to a carbon cloth patch of a 50 cm² size. A soft brush was used to evenly spread the ink over the carbon cloth surface. The ink readily penetrated through the entire bulk and it was apparent that the active particles were spread out over the whole surface area of the carbon cloth without blocking its porosity. The treated carbon cloth was placed into a convection oven at 150° C. to evaporate all volatiles. The completely dried piece was sintered at 350° C. for 30 min in a flow of N₂. The final loading was 0.020 mg Pt/cm². The carbon cloth was designated as GDM B3.

### EXAMPLE 5

### Preparation of an Activated GDM with 0.075 mg Pt/cm² using a Catalyst Powder of 20% Pt/12% Cu₂[Fe(CN)₆] (GDM C1)

3.0 g of 20% Pt/12% Cu₂[Fe(CN)₆] on carbon black were mixed with 60 g iso-propanol, 40 g glycerol and 2.4 g PTFE emulsion (58.3% w/w of PTFE in water) and ball milled until a homogeneous suspension had formed. A small amount of the ink was applied to a carbon cloth patch of 50 cm² size. A soft brush was used to evenly spread the ink over the whole surface area of the carbon cloth without blocking its porosity. The treated carbon cloth was placed into a convection oven at 150° C. to evaporate all volatiles. The completely dried piece was sintered at 350° C. for 30 min in a flow of N₂. The final loading was 0.075 Pt/cm². The carbon cloth was designated as GDM C1.

### EXAMPLE 6

### Preparation of an Activated GDM with 0.026 mg Pt/cm² using a Catalyst Powder of 5% Pt/95% Al₂O₃ (GDM R1, a reference GDM)

1.0 g of 5% Pt/95% Al₂O₃ selective CO oxidation catalyst was mixed with 30 g iso-propanol, 20 g glycerol and 1.2 g PTFE emulsion (58.3% w/w of PTFE in water) and ball milled until a homogeneous suspension had formed. A small amount of the ink was applied to a carbon cloth patch of a 50 cm² size. A soft brush was used to evenly spread the ink over the carbon cloth surface. The ink readily penetrated through the entire bulk and it was apparent that the active particles were spread out over the whole surface area of the carbon cloth without blocking its porosity. The treated carbon cloth was placed into a convection oven at 150° C. to evaporate all volatiles. The completely dried piece was sintered at 350° C. for 30 min in a flow of N₂. The final loading was 0.026 mg Pt/cm². The carbon cloth was designated as GDM R1.

### EXAMPLE 7

### Protocol for the Generation of Polarization Curves of Examples 8 to 10

Membrane electrode assemblies (MEA) were prepared by the decal transfer method as described in U.S. Pat. Nos. 5,234,777 and 5,211,984. The electrocatalyst was a 40 wt. % Pt on carbon black powder, the carbon black having a BET surface area of about 240 m²/g. A perfluorosulfonic acid polymer membrane having a thickness of 51 μm and a basis of 100 g/m² (Nafion® 112, DuPont Fluoroproducts, Fayetteville, N.C.) was used as polymer electrolyte membrane. The carbon to polymer ratio (w/w) in the electrode layers was 1. The metal loading on the electrodes was 0.3 mg Pt/cm² on the anode and 0.6 mg Pt/cm² on the cathode. There was no other active catalytic component, e.g., ruthenium, present on the anode. A sheet of carbon cloth served as gas diffusion layers on the cathode side A layer of carbon black and PTFE—known as microporous layer to those skilled in the art—was applied to the side facing the electrode. The GDMs prepared in Examples 1-6 were placed in the assembly on the anode side so that the catalyst layer faced the electrode. This assembly was sandwiched between graphite flowfields with triple serpentine channels. Gold coated metal plates served as current collectors and PTFE coated fiberglass cloth as gasket material. The active electrode area was 50 cm².

Such a single cell assembly was used to collect the polarization data on a Hydrogenics Screener fuel cell test stand.

The single cell was temperature controlled at 80° C. and all gases were heated to 80° C. before entering the single cell. Humidification of the gas stream was achieved by passing the gas through a sparge bottle with deionized water set to a temperature of 80° C. on the anode and 64° C. on the cathode-side.

The test protocol included a total of 9 hours of potentiostatic conditioning at operating potentials of 600 mV and 300 mV with hydrogen gas as fuel and air as oxidant containing gas under load following gas flows with a constant stoichiometry of 2 on the anode and cathode for current densities greater than 0.15 A/cm² and a constant flow for current densities below 0.15 A/cm². All data was collected at a gauge pressure of 250 kPa.

Gases representing simulated reformer gases were mixed from bottled gases of certified composition: Ultrahigh purity hydrogen, bone dry grade CO₂, high purity N₂ and 1000 ppm CO/balance N₂ or 1% CO/balance N₂ were used to form the test gas compositions. The composition of the CO free simulated reformate was (on a dry basis) 48% H₂, 16% CO₂ and 36% N₂. Portions of the N₂ component were replaced by 1000 ppm CO/balance N₂ or 1% CO/balance N₂ to add CO containing simulated reformate streams.

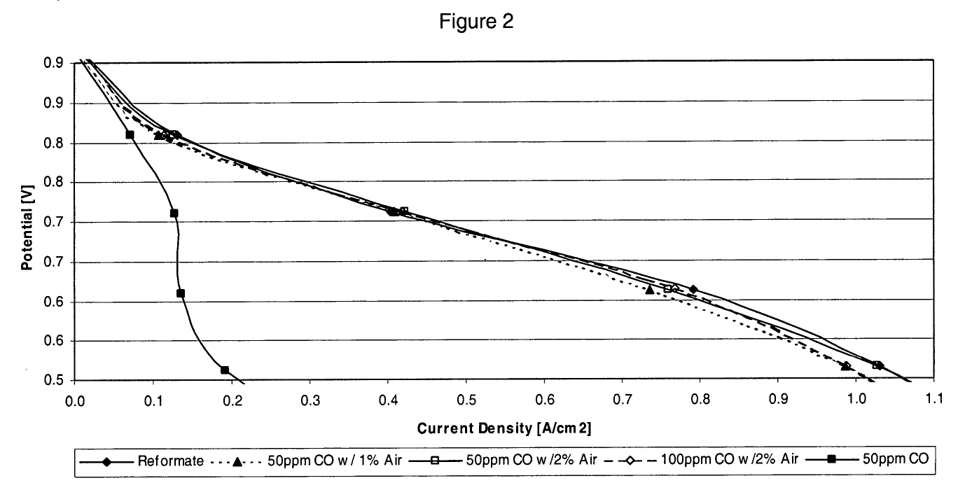

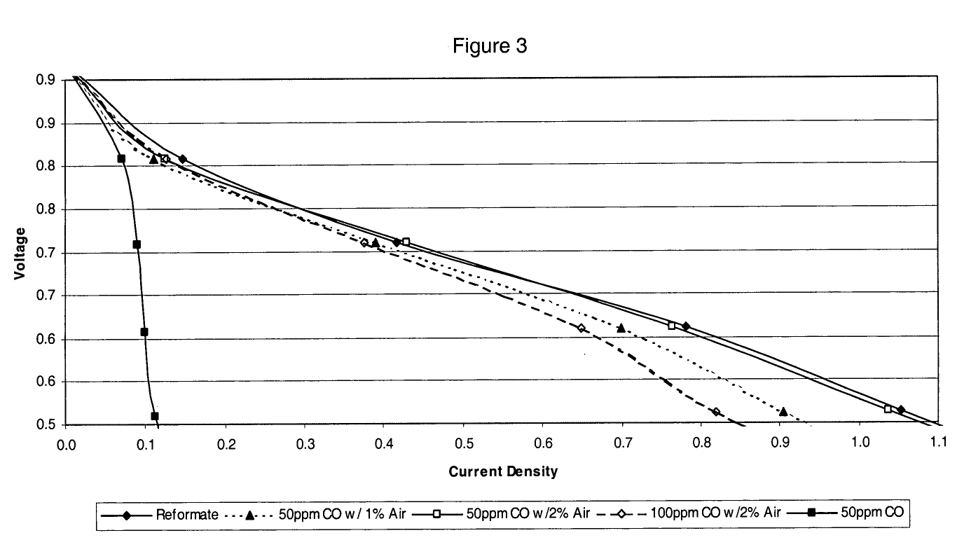

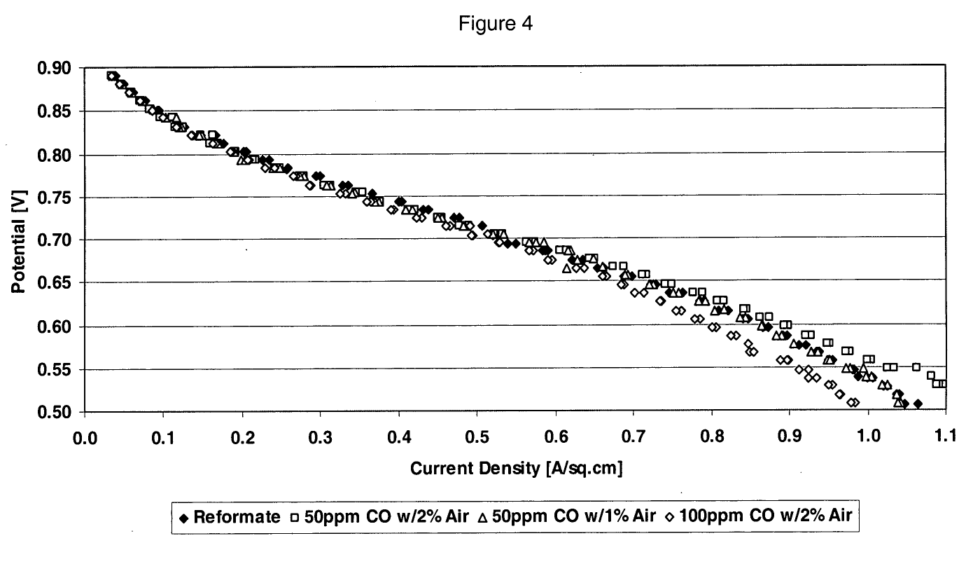

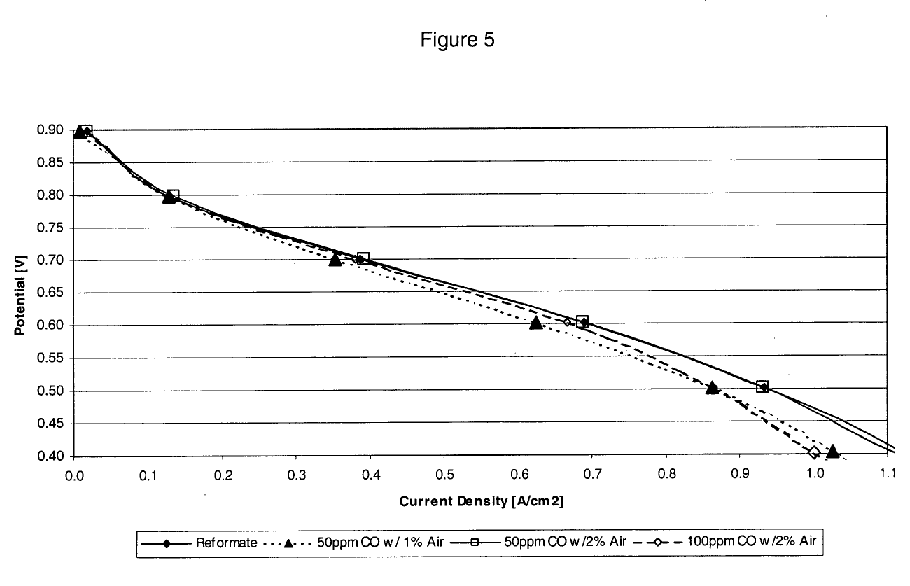

The cell voltage vs. current density characteristics for each fuel cell prepared with GDM B1, GDM B2, GDM B3 and GDM C1 were determined, and the results are shown in FIGS. 2-5, respectively. As can be seen in FIGS. 2, 3 and 5, when the fuel cell is operated with test gas compositions that contain 50 ppm CO without any air bleed, voltages >0.5 V are not observed at current density of 0.3 or higher. While not being bound by any specific theory, Applicants believe the untreated CO in the test gas composition poisons the platinum-containing anode and thereby degrades the efficiency of the fuel cell.

However, as can be observed in FIGS. 2-5, data curves generated for fuel cells operated with test gas compositions that contain either 50 or 100 ppm of CO with air bleed (either 1 or 2% air) are similar to those data curves generated for the reformate gas (containing no CO). The fuel cell's efficiency is maintained as evidenced by the relatively high potentials maintained throughout the current density range tested.

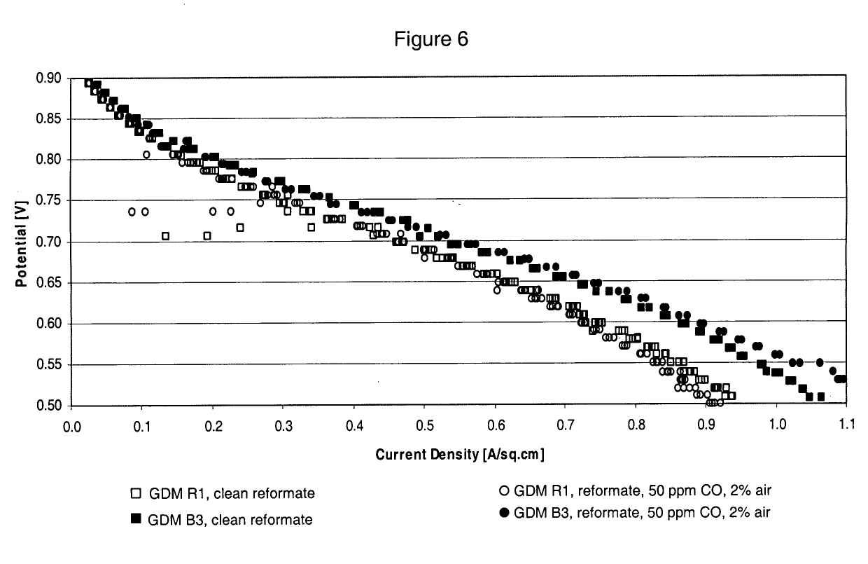

FIG. 6 shows a comparison of the fuel cell voltage vs. current density for a fuel cell containing GDM B3 and a fuel cell containing the reference GDM, GDM R1. GDM B3 was prepared with a selective CO oxidation catalyst containing an electronically conductive particulate support (see Example 4), while GDM R1 was prepared with a selective CO oxidation catalyst prepared with a particulate support (alumina) that is not electronically conductive (see Example 6), but is electronically insulating. As can be observed in FIG. 6, cell potentials associated with the fuel cell operated with GDM B3 were higher than those associated with the fuel cell operated with GDM R1 across the entire range of current densities tested. This trend was consistent even where the fuel cells were operated with clean reformate gas (i.e., no CO present). The results demonstrate the superior performance of fuel cells equipped with GDMs having oxidation catalysts having an electronically conductive particulate support over fuel cells equipped with GDMs having oxidation catalysts with electronically insulating supports.

While this invention has been described with an emphasis upon preferred embodiments, it will be obvious to those of ordinary skill in the art that variations in the preferred devices and methods may be used and that it is intended that the invention may be practiced otherwise than as specifically described herein. Accordingly, this invention includes all modifications encompassed within the spirit and scope of the invention as defined by the claims that follow.

What is claimed:

1. A fuel cell, comprising:
a selective CO oxidation catalyst with an electronically conductive, particulate support dispersed on a gas diffusion membrane, and
and a membrane electrode assembly.

2. The fuel cell of claim 1, wherein the electronically conductive, particulate support has a surface area >50 m²/g.

3. The fuel cell of claim 1, wherein the electronically conductive, particulate support is selected from one or more of graphite, carbon black, an electronically conducting polymer, and an electronically conducting oxide.

4. The fuel cell of claim 1, wherein the electronically conductive particulate support is carbon black having a surface area >200 m²/g.

5. The fuel cell of claim 1, further comprising an anode side flow field, wherein the gas diffusion membrane having the dispersed CO selective oxidation catalyst is interposed between the anode side flow field and the membrane electrode assembly.

6. The fuel cell of claim 1, wherein the gas diffusion membrane comprises woven or non-woven carbon fibers.

7. The fuel cell of claim 1, wherein the selective CO oxidation catalyst comprises a platinum group metal component selected from the group consisting of platinum-, palladium-, iridium-, rhodium-, ruthenium components and alloys thereof.

8. The fuel cell of claim 7, wherein the selective CO oxidation catalyst comprises a platinum component.

9. The fuel cell of claim 8, wherein the selective CO oxidation catalyst is present on the gas diffusion membrane at from 0.01 to 0.4 g/in² of a platinum component.

10. The fuel cell of claim 1, the selective CO oxidation catalyst comprises a metal component selected from the group consisting of copper-, gold components and alloys thereof.

11. A method of supplying a purified reformate gas to a membrane electrode assembly, comprising:
(a) contacting a reformate gas comprising H₂ and CO with a gas diffusion membrane having dispersed thereon a selective CO oxidation catalyst with an electronically conductive, particulate support while simultaneously adding an oxidant to the reformate gas to convert at least some of the CO to CO₂ to form the purified reformate gas, and
(b) passing the purified reformate gas to the membrane electrode assembly.

12. The method of claim 11, wherein the oxidant comprises O₂.

13. The method of claim 12, wherein the O₂ is in the form of air.

14. The method of claim 11, wherein the CO in the reformate gas of (a) is present at from 5 to 5000 ppm.

15. The method of claim 11, wherein the purified reformate gas contains between 10 and 50 ppm of CO.

16. A method of supplying electrical current to an electrically-powered device having transient power demands, comprising:
(a) contacting a reformate gas comprising H₂ and CO with a gas diffusion membrane having dispersed thereon a selective CO oxidation catalyst with an electronically conductive, particulate support while simultaneously adding an oxidant to the reformate gas to convert at least some of the CO to CO₂ to form purified reformate gas having a concentration of the CO to below 100 ppm;
(b) passing the purified reformate gas to the membrane electrode assembly;
(c) generating a current to power the electronically-powered device, wherein the device has a power demand X; and,
(d) lowering the power demand of the electrically-powered device to at least 1/10*X; and maintaining the CO concentration in the purified reformate gas below 100 ppm.

17. The method of claim 16, wherein the CO concentration in the purified reformate in (a) and (b) is below 10 ppm.
